(19) United States
(12) Patent Application Publication
(10) Pub. No.: US 2024/0227372 A1
(43) Pub. Date: Jul. 11, 2024

(54) MULTILAYER COMPOSITE STRIP FOR INCREASING RIGIDTY

(71) Applicant: GREEN EAGLE USA, LLC, Georgetown, SC (US)

(72) Inventor: Guerry E. Green, Georgetown, SC (US)

(21) Appl. No.: 18/010,940

(22) PCT Filed: Aug. 31, 2022
(86) PCT No.: PCT/US22/42159

§ 371 Date: Dec. 16, 2022

(51) Int. Cl. B32B 27/12; B32B 5/02; B32B 27/30; B32B 27/34; B32B 27/36

(52) U.S. Cl. CPC B32B 27/12; B32B 5/028; B32B 27/304; B32B 27/34; B32B 27/36; B32B 2250/05; B32B 2260/023; B32B 2260/046; B32B 2262/06; B32B 2262/101; B32B 2262/106; B32B 2307/536; B32B 2307/54; B32B 2307/714; B32B 2307/7265; B32B 2307/7376; B32B 2419/00

(57) ABSTRACT

Aspects of a multilayer composite strip for increasing rigidity in materials is disclosed. In one aspect, the multilayer composite strip comprises a first polymeric layer, a first mesh layer, wherein at least 20 percent of the first mesh layer is a void region, a composite layer of shredded fibrous material and polymeric material, and a second mesh layer, and a second polymeric layer. In said aspect the multilayer composite strip is formed by heating, cooling, and/or compressing, including rolling and stretching to form a rigid composite strip that may be further mechanically or chemically bonded to other polymers or building materials so as to increase stiffness and restrain lateral movement.

### FIELD

The present invention relates to a multilayer composite strip for use in strengthening materials. In particular, a multilayer composite strip for adding rigidity to polymers and building materials.

### BACKGROUND

The present disclosure relates generally to a multilayer composite strip for enhancing or improving the rigidity or strength of polymers and building materials. Virtually all extrusion polymers can be enhanced with reinforcements, fillers, and additives to achieved desired properties. There are two main types of reinforcements, one is a fiber reinforcement such as glass or carbon fiber that can be added to a polymer matrix to improve the mechanical and thermal properties of extruded materials. A second is through coextrusion, wherein reinforcing materials can be extruded simultaneously (coextruded) with a polymeric material to improve strength and to provide improvements in mechanical properties.

Typically, a coextruded stiffening material includes a polymer with a high durometer that is applied to one with a lower durometer. Alternatively, a preformed metal may be coextruded with a polymer to create a plastic-metal hybrid extrusion. The addition of metal typically increases the cost and also requires special additives or other material for adhesion.

There exists a need to apply the technologies of fiber reinforcement to applications that may be extruded, formed, shaped, combined (mechanically, chemically), or coextruded depending upon a given application. Further, to allow such applications to be manufactured rapidly, including by precise particulate and matter sizing to allow rapid setting. The disclosure herein provides for a multilayer composite strip that provides superior mechanical properties of fiber reinforcement, coupled with the ability to be mechanically and physically bonded into a final product. Thus reducing cost and utilizing waste or otherwise materials within the recycling chain to provide enhance mechanical properties in extrusions.

### SUMMARY

In some aspects, the techniques described herein relate to a multilayer composite strip for increasing rigidity in polymeric materials, including: a first polymeric layer with a layer height ranging from 0.23 mm to 1.1 mm; a first mesh layer, wherein at least 20 percent of the first mesh layer is a void region; a composite layer of shredded fibrous material and polymeric material, wherein the shredded fibrous material is of an average length between 5.0 mm and 50 mm, and the polymeric material has a granular size from 50 microns to 2000 microns prior to heating; a second mesh layer, wherein at least 20 percent of the second mesh layer is a void region; and a second polymeric layer with a layer height from 0.23 mm to 1.1 mm.

In some aspects, the techniques described herein relate to a multilayer composite strip, wherein the first polymeric layer and the second polymeric layer is included of polyethylene terephthalate (PET) or polyethylene terephthalate glycol (PETG).

In some aspects, the techniques described herein relate to a multilayer composite strip, wherein the first polymeric layer is included of polyvinyl chloride (PVC).

In some aspects, the techniques described herein relate to a multilayer composite strip, wherein the first polymeric layer further includes polyamides.

In some aspects, the techniques described herein relate to a multilayer composite strip, wherein the first mesh layer and the second mesh layer have a window size between 1 mm to 12 mm.

In some aspects, the techniques described herein relate to a multilayer composite strip, wherein the composite layer of the shredded fibrous material is shredded carbon fiber.

In some aspects, the techniques described herein relate to a multilayer composite strip, wherein the composite layer of the shredded fibrous material is shredded fiberglass.

In some aspects, the techniques described herein relate to a multilayer composite strip, wherein the composite layer of the shredded fibrous material is shredded bast fibre.

In some aspects, the techniques described herein relate to a multilayer composite strip, further including a third mesh layer, a second composite layer of the shredded fibrous material and the polymeric material, and a third polymeric layer, the second composite layer being of a different shredded fibrous material than the first composite layer.

In some aspects, the techniques described herein relate to a multilayer composite strip, wherein the multilayer composite strip is between 1 mm to 20 mm in height and up to 550 mm in width.

In some aspects, the techniques described herein relate to a multilayer composite strip, wherein the first and second mesh layer have a tensile strength of 9,000 psi.

In some aspects, the techniques described herein relate to a multilayer composite strip, wherein the multilayer composite strip is water resistant and noncorrosive.

In some aspects, the techniques described herein relate to a multilayer composite strip, wherein the first polymeric layer, the first mesh layer, the composite layer, the second mesh layer, and the second polymeric layer are integrated to form a solid layer.

In some aspects, the techniques described herein relate to a multilayer composite strip for increasing rigidity in materials, including: a first polymeric layer with a layer height ranging from 0.23 mm to 1.1 mm; a first mesh layer of fiberglass, wherein at least 20 percent of the first mesh layer is a void region; a composite layer of shredded fibrous material and polymeric material, wherein the shredded fibrous material is of an average length between 5.0 mm and 50 mm, and the polymeric material has a granular size from 50 microns to 2000 microns prior to heating; a second mesh layer of fiberglass, wherein at least 20 percent of the second mesh layer is a void region; and a second polymeric layer with a layer height from 0.23 mm to 1.1 mm.

In some aspects, the techniques described herein relate to a multilayer composite strip, wherein the first polymeric layer and the second polymeric layer is included of polyethylene terephthalate (PET) or polyethylene terephthalate glycol (PETG).

In some aspects, the techniques described herein relate to a multilayer composite strip, wherein the first polymeric layer is included of polyvinyl chloride (PVC).

In some aspects, the techniques described herein relate to a multilayer composite strip, wherein the first mesh layer and the second mesh layer have a window size between 1 mm to 12 mm.

In some aspects, the techniques described herein relate to a multilayer composite strip, wherein the composite layer of the shredded fibrous material is shredded carbon fiber.

In some aspects, the techniques described herein relate to a multilayer composite strip, wherein the composite layer of the shredded fibrous material is shredded fiberglass.

In some aspects, the techniques described herein relate to a multilayer composite strip, wherein the composite layer of the shredded fibrous material is shredded bast fibre.

In some aspects, the techniques described herein relate to a multilayer composite strip, further including a third mesh layer, a second composite layer of the shredded fibrous material and the polymeric material, and a third polymeric layer, the second composite layer being of a different shredded fibrous material than the first composite layer.

### BRIEF DESCRIPTION OF THE DRAWINGS

Many aspects of the present disclosure will be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views. It should be recognized that these implementations and embodiments are merely illustrative of the principles of the present disclosure. Therefore, in the drawings:

FIG. 1 is an exploded perspective view of an example of the various layers of a multilayer composite strip as disclosed herein;

FIG. 2 is a perspective view of an example of a formed multilayer composite strip from FIG. 1, as disclosed herein;

FIG. 3 is an additional exploded perspective view of an example of the various layers of a multilayer composite strip as disclosed herein;

FIG. 4 is a perspective view of an example of a formed multilayer composite strip from FIG. 3, as disclosed herein;

FIG. 5 is an illustration of an example layer of PET polymeric material;

FIGS. 6A-B is an illustration of an example mesh layer of fiberglass mesh;

FIG. 7 is an illustration of an example composite layer of shredded carbon fiber fibrous material;

FIG. 8 is an illustration of an example polymeric layer of PETG polymeric material;

FIG. 9 is an illustration of an example composite layer of shredded fibrous material; and

FIG. 10 is a flow diagram of an example method of forming a multilayer composite strip.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

Throughout this specification and the claims, the terms “comprise,” “comprises,” and “comprising” are used in a non-exclusive sense, except where the context requires otherwise. Likewise, the term “includes” and its grammatical variants are intended to be non-limiting, such that recitation of items in a list is not to the exclusion of other like items that can be substituted or added to the listed items.

### I. Example Use Case Scenarios

Increasing the rigidity of polymeric extrusions, co-extrusions, polymeric forming, and building materials plays an important role in fabricating many products. Polymers tend to lack rigidity, as well as physical properties that allow them to replace traditional wood and metal products. As such, the disclosure herein seeks to impart the beneficial properties of wood and metal, with the properties of polymers-such as resistance to weather and corrosion, along with stiffness and ease of machining/utilizing. In one aspect, the use of the disclosure herein may apply to forming of windows and doors, including jambs, sills, and other elements of a window or door. In other aspects, the disclosure herein may apply to building materials, such as wood products, and polymer products, to impart the beneficial properties of polymeric material.

Additionally, applications of the multilayer composite strip disclosed herein may aid in window treatments and allow for decreased weight of window treatments. Including elements such as the slats, the valance, head rails, and more. Further, additional embodiments may be used to fortify applications of other extrusions or co-extrusions, and in particular extrusions that are designed to stand up to the elements, for example in such products as deck boards, boat surfaces, overhead installations, to name a few.

In further aspects, military applications such as strengthening machinery, hardware, cases, and other military products may be achieved with the disclosure herein. In one aspect, the multilayer composite strip provides lower weight and similar properties to metals such as aluminum and steel. This is accomplished by the addition of shredded fibrous material of a particular length with a polymeric powder that is integrated with several layers to form the disclosure herein. In other aspects, the polymeric layers provide impact resistance and resistance from corrosion. Such applications prove useful in military applications where the environment is often changing.

In other aspects, the waterproof and elemental resistance of said disclosure improves usage in existing applications, such as for concrete tensioning, extrusion tensioning, and marine applications. Further, the cross structure of mesh layers and shredded fibrous material allows for cross planar rigidity and tension resistance. These enhancements allow extrusions and other applications to excel at tension properties, rigidity applications, and overall usage around corrosives.

### II. With Reference to Figures

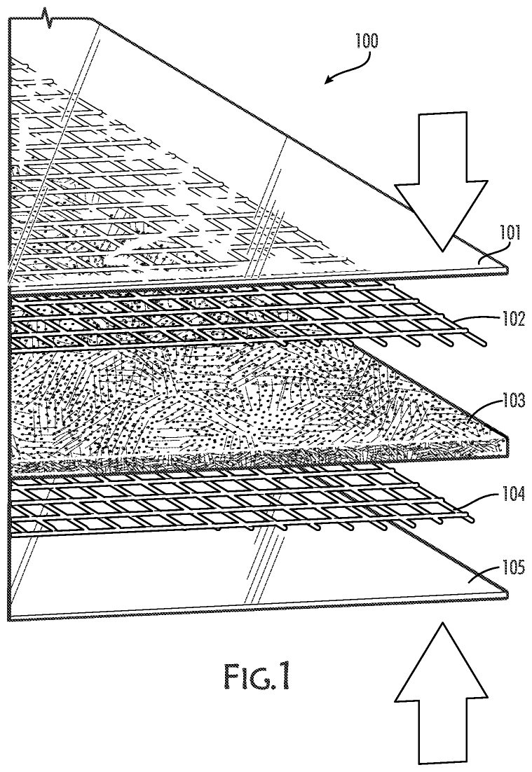

Referring now to FIG. 1, an exploded perspective view of an example of the various layers of a multilayer composite strip 100 as disclosed herein. In this example, a multilayer composite strip 100 comprises five layers. In other examples, there may be as many as twenty-five layers, depending upon the need of the application. In this example, a first layer of polymeric material 101, with a layer height ranging from 0.23 mm to 1.1 mm is utilized. It is found from the disclosure herein that said range performs optimally when combining with the additional layers. In other embodiments the layer height may increase or decrease with variability of plus or minus ten percent and still perform as contemplated. Further, the first polymeric layer may be any polymer suited for the needs, and several polymeric materials are highlighted herein. In this example a polyethylene terephthalate (PET) is utilized due to its broad melt point and ability to bind with the consecutive layers. In other aspects, PETG, PVC, PLA, or other polymers may be utilized together or in combination.

In one example, a powdered form of polymeric material is applied to form the polymeric layer, in doing so the powder is melted to a temperature that allows it to flow through the mesh layer and to bind with the composite layer, eventually flowing from the top and bottom side to congeal around all layers forming the multilayer composite strip. In another example, polymeric material sheets are utilized to form the polymeric layer, in yet another example, a flake polymeric material, or a shredded polymeric material, or pulverized polymeric material, may be used to form the polymeric layer. In the example, PET powder is utilized for the first and second polymeric layers. In other aspects, sheets of a polymeric material may be rolled out and the mesh layer applied, then heated to form a carrier or binder layer, comprising at least a polymeric layer and a mesh layer. The carrier is then rolled up and placed on holding racks. Each carrier roll may be considered a first carrier, and a second carrier, and so on. Further, the carriers may be comprised of different mesh layers, but with similar polymers or polymers that are capable of bonding through melting and cooling—typically a mechanical or chemical bond.

Continuing, in the example of FIG. 1, a first mesh layer 102 is disclosed, wherein the first mesh layer 102 is comprised of fiberglass, and further, wherein at least 20 percent of the first mesh layer 102 is a void region. A void region is a region where no fiberglass or other material forming the mesh, such as a metal or glass materials, exists. This mesh layer may also be comprised of a polymeric mesh, or of a metal mesh, such as steel mesh, so long as the void regions are present to allow the polymeric layer to integrate into the voids.

In further detail, the void regions serve to accept the first mesh layer 102 and to bind by allowing the first mesh layer 102 to compress into the first polymeric layer 101, thus forming a carrier layer or binding layer for receiving a composite layer 103. The usage of mesh restrains lateral movement, or movement along a belt in manufacturing and further adds rigidity as a lattice structure to the composite layer.

Highlighting other materials for the mesh layer, a mesh layer may be comprised of other materials, such as metals-aluminum, steel, as well as other polymers that may have a higher melting point then the polymeric layer. For example, the mesh layer may be comprised of nylon, which has a higher melting point then the first polymeric material (PET), wherein the nylon maintains integrity when heated to the melting point of the PET polymeric layer.

In the example of FIG. 1, the composite layer 103 comprises shredded fibrous material and polymeric material, wherein the length of the shredded fibrous materials is between 5.0 mm and 50 mm and the polymeric material is of a powder form ranging from 50 microns to 2000 microns. The polymeric material combined with the shredded fibrous material may be any powder polymeric material, flaked polymeric material, or pelletized polymeric material that has the ability to melt in the manufacturing process, which, through experimentation typically ranges between 50 microns and 2000 microns.

The shredded fibrous material may vary in lengths from the stated dimensions by plus or minus ten percent and still perform optimally. The composite layer 103 forms the strength layer, wherein it increases rigidity, stiffness, and tensile strength by binding with the first polymeric layer and the first mesh layer, once heated and compressed, the multiple layers form a latticed structure with rigidity across both horizontal and vertical planes. Thus, when the composite layer 103 is placed onto the first polymeric layer 101 and the first mesh layer 102 (together the first carrier or binder), the organization of the fibrous materials creates a random assortment of directionality, that when congealed into the multiple layers (the first carrier and the second carrier), forms a rigid structure that resists flexing or bending in multiple directions. This composite strip forms desired aspects, including, when applied to other materials, increases the overall stiffness while adding a low amount of weight.

Continuing, in the example, the composite layer 103 of shredded fibrous material may be comprised of carbon fiber, fiber glass, or bast fibres. Shredded carbon fiber performs optimally with regard to weight savings and overall increase in stiffness. Fiberglass allows for resistance to moisture aspects and corrosives. Bast fibres, also known as phloem fibre, is a plant derived fibre collected from the phloem or inner bar of a plant. Bast fibres are classified as soft fibres and are flexible in nature. Examples of bast fibre materials include, but are not limited to, flax, hemp, jute kenaf, kudzu, linden, milkweed, nettle, okra, paper mulberry, ramie, and roselle hemp. Further, bast fibres are renewable and serve to lower the overall environmental impact of extrusions and building materials by incorporating raw fibers as an agent for increasing rigidity. The disclosure herein provides that a composite layer may be comprised of bast fibres, amongst other fibres, that are shredded to a length between 5.0 mm to 50 mm for optimal orientation on the mesh and polymeric layer. These fibers are then submitted to pelletized polymers, and through heating form the composite layer. This layer is the strengthening layer, and provides the rigidity that may be incorporated into building materials and other polymers.

In one example, the bast fibre shredded materials is impregnated with polymeric powder, and then placed within the mesh and polymeric layer, and through heating/cooling and rolling, forms an integrated layering and the multilayer composite strip. An integrated layer is a layering where the layers are heated together making it difficult to separate, but together forming the rigidity that is desired. In the example, the multiplicity of composite layers further increases rigidity. For example, by having a first and second carrier, a third carrier may be added so as to include another composite layer, further increasing rigidity. In another example the bast fibre shredded materials is impregnated with polymeric pellets, and then placed within the mesh and polymeric layer, and through heating/cooling and rolling/stretching, forms an integrated layering and the multilayer composite strip. In yet another example the bast fibre shredded materials is impregnated with a polymeric sheet, and then placed within the mesh and polymeric layer, and through heating/cooling and rolling/stretching, forms an integrated layering and the multilayer composite strip.

In some examples, shredded carbon fiber or shredded fiberglass may be used to form the composite layer, along with a polymeric material, and when integrated with a polymeric layer, such as polyethylene terephthalate and a mesh layer, forms a multilayer composite strip that is rigid against forces and displays strong tensile ability. Further, said multilayer composite strip is resistive to most corrosives and may combined into other products as a stiffening agent or rigidity structure, such as pushed through a cross head die or otherwise chemically or mechanically combined.

In other aspects, the composite layer may have other additives, such as resins utilized in manufacturing carbon fiber, or additives that increase the adhesion to polymeric material, or additives that enhance the polymeric layer strength prior to subjecting to the mesh layer to form a carrier. In other aspects, the composite layer may be mixed with a polymeric material as it is displaced on the mesh layer. In yet further embodiments, the composite material may be dry or lack any additional additives, and may be raw fiberglass or carbon fiber. Further, in some aspects, the techniques described herein relate to a multilayer composite strip, wherein the multilayer composite strip is between 1 mm to 20 mm in height and up to 550 mm in width in finished form prior to being combined with or applied to other materials.

Continuing with FIG. 1, a second mesh layer 104 of fiberglass is added to the previous layers along with a second polymeric layer 105 with a layer height from 0.23 mm to 1.1 mm. In the example, the first and second mesh layers 104 may be of a glass or fiber mesh that is constructed to reduce lateral forces when the layers are combined and pulled through an extruder. Further, the first and second mesh layers allow for binding or melting with the polymeric layer and the composite layer, as the voids allow the polymeric layer to melt into the other layers and congealing to form a multilayer composite strip. Combined, the multiple layers form a “sandwich” in which the polymeric material and mesh layer forms the outmost layer or “bread” layers, these are referred to as the carrier or binder. The composite layer forms the center or “meat” layer. When heated and compressed, the multilayer composite strip 100 is rigid across all directions, resistant to water and corrosives, and is capable of being extruded, physically or chemically formed, and/or adhered with other polymers or building materials, including things such as wall panels, to form a strengthening agent or rigid member or structure for application to a variety of products.

Examples of polymeric materials disclosed for various applications herein:

| Polymeric Material | Properties |
|---|---|
| Low-density polyethylene (LDPE) | Chemically inert, flexible, insulator |
| High-density polyethylene (HDPE) | Inert, thermally stable, tough and high tensile |
| | strength |
| Polypropylene | Resistant to acids and alkalies, high tensile |
| | strength |
| Polyvinyl chloride (PVC) | Insulator, flame retardant, chemically inert |
| Polychlorotrifluoroethylene (PCTFE) | Stable to heat and thermal, high tensile |
| | strength and non-wetting |
| Polyamide (Nylon) | High melting point, excellent abrasion |
| | resistance |
| Polyethylene terephthalate (PET) & (PETG) | High strength and stiffness, broad range of use |
| | temperatures, low gas permeability |

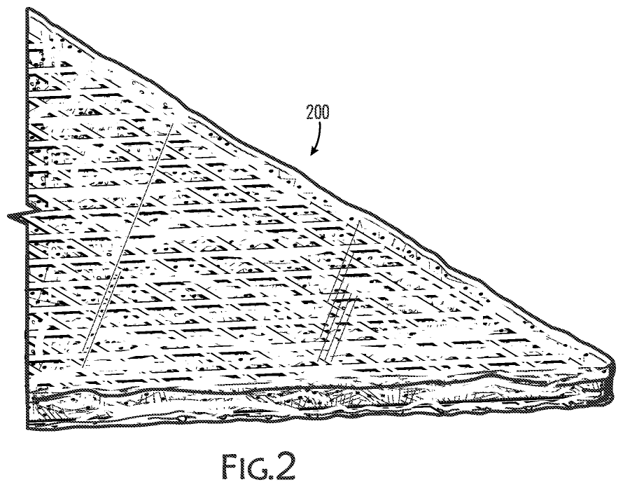

Referring now to FIG. 2, a perspective view of an example of a formed multilayer composite strip 200 from FIG. 1. In the example the layers are fused or melted together with the first and second polymeric layers forming a “glue” substrate that penetrates the first and second mesh layers and mixes with the composite layer to form a rigid structure. The rigid structures properties allow for incorporation into a variety of building materials and products. Further, because the layering of the multilayer composite strip may be adjusted, the relative strength properties can be tuned to desired outcomes. For instance, the incorporation of additional composite layers increases stiffness/rigidity. Whereas, additional polymer layers may add more protective coatings, or allow for a larger layer height for various applications.

In the example, the multilayer composite strip 200 is formed by dispersing a first polymeric layer, such as a polymeric sheet or polymeric granules, and melting said sheet or granules to form a layer height ranging from 0.23 mm to 1.1 mm of polymeric material. Next, applying first mesh layer, that may comprise fiberglass or other glass, polymer, or metal mesh, to the first polymeric later. Together they form a carrier, in which may receive the composite layer. When applying the mesh layer, it may be rolled onto, placed, heated, cooled, and/or pressed onto the polymeric layer so that the polymeric layer fuses with the mesh layer forming a binder for receiving a composite layer. This fusion may be chemically or mechanically, and may involve pressing, rolling, heating, cooling, and other mechanical or chemical bonding as may be necessary.

Next, the carrier layer, comprising the polymeric layer and the mesh layer have a composite layer of shredded fibrous material and polymeric powder added by either dispersing, dropping, adhering, spreading, dusting, or placing onto the first carrier. Wherein the second carrier may then be rolled on top of the composite layer, forming a sandwich. In one aspect, the first mesh layer and the first polymeric layer are melted with the composite layer, thus the PET from the carrier layer and the composite layer are fused together. Turning to the composite layer, wherein depositing the shredded fibrous material and the pelletized polymeric material, is conducted by placing each of said materials through a shaker or sorter onto the carrier. The carrier (first polymeric layer and first mesh layer), then integrates and binds to the previous layers through a mechanical or chemical process. To finish the example multilayer composite strip, a second carrier, similar to the first, is applied to the first carrier and the composite layer. This process of layering may include additional composite layers, mesh layers, or polymeric layers, depending upon the application and rigidity required. The layers may also be comprised of different materials, for example, a first carrier may have a fiberglass mesh, and a second carrier may have a steel mesh or a nylon mesh. Further, certain machine apparatuses are limited by the overall layer height, thus the multilayer composite may be re-melted and applied or stacked, and may be comprised of several multilayer composite strips “baked” together to form larger rigid structures.

In the example, the mesh layers allow for lateral force reduction and aide in the placement of the multilayer composite strip within other extrusions and building materials. Further, said mesh layers provide a semi rigid structure for the polymeric material to adhere to, which in turn helps lateral restraint when being pulled through rollers into heating and cooling zones, and accompanied with the composite layer, then provides multi directional restraint. In forming the multilayer composite strip a series of steps of heating and cooling, along with compression and rollers allow the multilayer composite strip to be formed as an ongoing process and also allows for the addition of subsequent layers, such as additional composite layers, and additional polymeric layers.

As disclosed herein, the numerosity of layers is only limited by the capacity to form into a multilayer composite strip. As well with the application of the multilayer composite strip with other materials. Thereby the multilayer composite strip may consist of multiple composite layers, adhered to singular or multiple mesh and polymeric layers.

In shredding the base material to form the composite layer it is disclosed that a 5.0 mm to 50 mm size on average results in optimal strength and rigid properties when fused to the other layers. The shredding of a base material such as carbon fiber, fiberglass, or bast fibre by its very nature results in sizes outside of the optimal parameters. However, it is anticipated that the 5.0 mm to 50 mm size is an average range based on the total composition of shredded material, and that such optimal range will result in a stronger multilayer composite strip.

The mesh layer having void regions for polymeric adhesion allows for a rigid layer to resist lateral forces, not only in the manufacture of the composite strip, but also when formed. The manufacture of the multilayer composite strip necessarily requires rolling and unrolling, as well as applications to rollers, pulling, stretching, and the like, the mesh layer provides restraint to maintain dimensions and to further support the composite layer application.

The void regions provide space for the polymeric layer and material to combine with the composite layer, thereby forming a rigid multilayer composite strip. The disclosure provides herein that rigidity may be increased by increasing the number of mesh layers and composite layers, and one is not necessarily equal to the other. The composite layer provides for resistance in all directions, whereas the mesh layers show stronger resistance on lateral forces. Further, differing materials may be utilized in each layer, so long as the final result is an integrated multilayer composite strip.

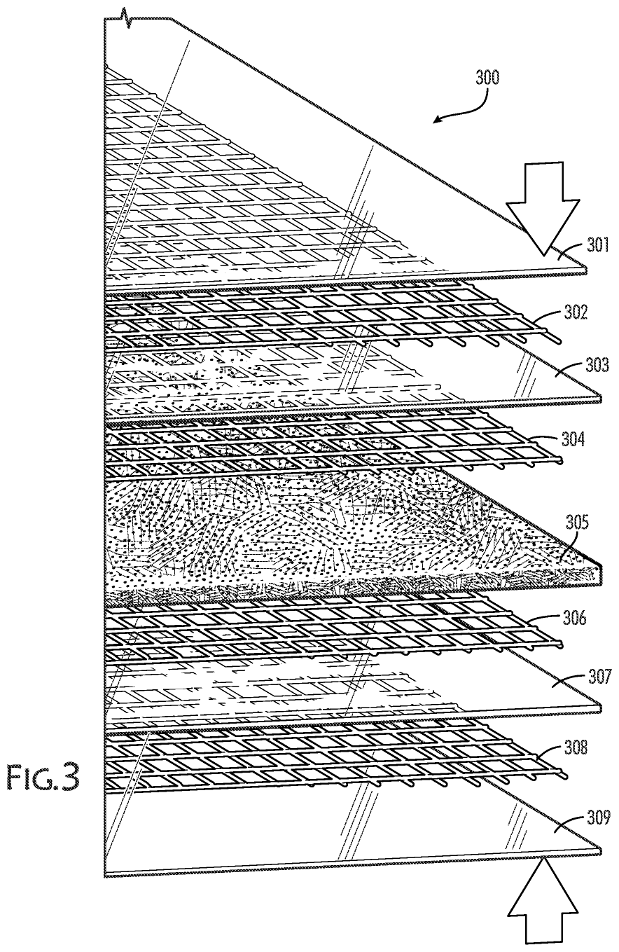

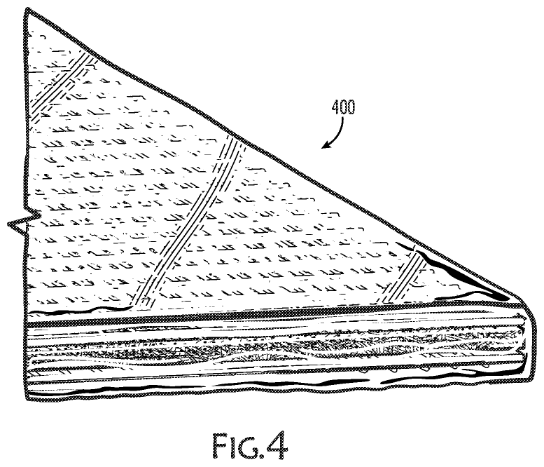

Referring now to FIG. 3, an additional exploded perspective view of an example of the various layers of a multilayer composite strip 300. In the example, a first polymeric layer 301 is melted to a first mesh layer 302, wherein the first polymeric layer may be comprised of PET, or PETG, and the first mesh layer may be a steel mesh layer, or a vinyl mesh layer, or a fiberglass mesh layer, to name a few examples. In the example, the second polymeric layer 303 is added to a second mesh layer 304, and a first composite layer 305 is adhered to the corresponding previous layers. In other examples, the composite layer may be between every polymeric and mesh layer, thereby having multiple composite layers. Continuing, the third mesh layer 306 is melted to or added to a third polymeric layer 307. Followed by a fourth mesh layer 308 and a fourth polymeric layer 309. The corresponding layers process through steps of heating and cooling, and compression along rollers to form a multilayer composite strip as disclosed in FIG. 4.

Referring now to FIG. 4, a perspective view of an example of a formed multilayer composite strip 400 from FIG. 3. In the example the overall height of the multilayer composite strip is increased due to the increase in layers. In some example the multilayer composite strip may reach over 150 mm in height, and in others it may be combined with additional multilayer composite strips to reach even higher dimensions.

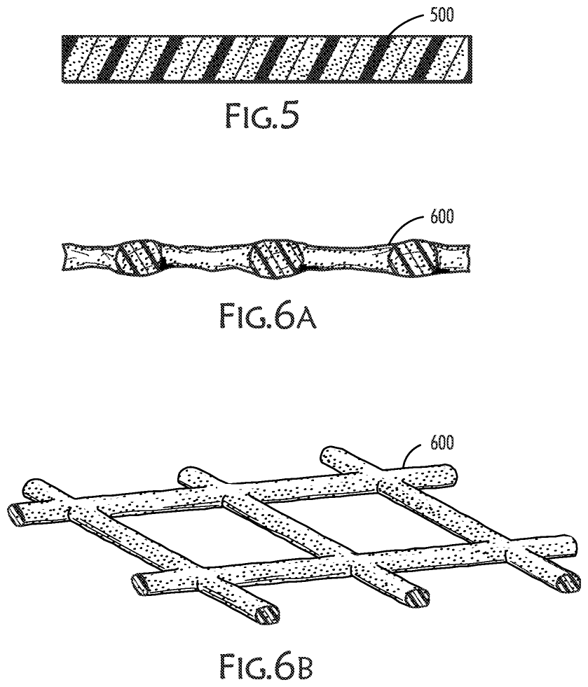

FIG. 5 is an illustration of an example layer of PET polymeric material layer 500. In the example PET is disclosed for its physical properties disclosed herein. In other aspects, other polymeric materials may be utilized depending on the properties of the mesh layer and the composite layer. For example, PET and PETG melt and bond with fiberglass mesh and carbon fiber composite layers, and the ability to use such allows for consistent and rapid forming of a multilayer composite material. In other aspects, PVC may be utilized with a steel mesh and a fiberglass composite layer. The properties vary depending upon the choice of the various layers. For example, the polymeric material may be sheets of polymeric material, in other aspects it may be flaked polymeric material, powdered polymeric material, and even pelletized polymeric material, that is then heated to form the polymeric layer. Further, the layers may be mixed, for example the composite layer may comprise both shredded carbon fiber and shredded fiberglass to gain beneficial properties of both materials.

Continuing with FIG. 5, any polymeric material that has an adequate melt point to allow melting and adhering to a mesh layer and a composite layer may be utilized. In this disclosure several alternatives are disclosed, and one with ordinary skill in the art will recognize the various physical properties of the alternatives disclosed that would provide for melting and adhering to the corresponding layers.

FIGS. 6A and 6B is an illustration of an example layer of mesh material 600. In the example a fiberglass mesh is disclosed. In other aspects a steel mesh, a polymeric mesh with different melting points (such as a high melting point), such as a polyvinyl mesh may be utilized. It is important that the void region, often referred to as window size, of the mesh is substantial enough to allow proper melting of the polymeric material to fill the void regions and to allow the composite layer to trap into the void regions of the mesh layer. Thus, when selecting a mesh layer it is discovered that at least 20 percent of the mesh layer should occupy a void region, and while having at least 20 percent a void region still maintains a mesh layer that provides optimal lateral restraint to forces of the rollers and when tensioning in use. There is room for variance with regard to the mesh layer, depending on the particular use of the multilayer composite strip, however the addition of void regions allows for the permeation of the multiple layers and formation of an integrated layer. In additional aspects, the window size of the mesh layer may be between 1 mm to 12 mm, and may be further increased or decreased, so long as sufficient void region remains to accumulate the polymeric layers.

Referring now to FIG. 7, an illustration of an example composite layer of shredded carbon fiber fibrous material 700. As disclosed herein, carbon fiber is shredded to an average length of 5 mm to 50 mm, wherein said carbon fiber is displaced across the first polymeric layer and first mesh layer, wherein the fibers are compressed into the viscous polymeric material to form a physical binding, and in some cases a chemical bonding of the layers. In doing so the carbon fiber composite layer forms the strength layer, increasing overall rigidity without sacrificing weight or large volumes.

In other aspects shredded fiberglass may be used, or bast fibres, wherein the same shredding process reduces the overall length of the average of all fibers to between 5 mm and 50 mm. The shredding aspect orients the fibers in random directions, wherein allows the strength of the composite strip to be more or less uniform in any direction. Testing results indicate that lateral tensile forces are increased in part due to the mesh layer, however the multilayer composite strip shows aspects of strong tensile properties across the composite strip. This is due in part to the bonding of the layers and the orientation of the fibers in the composite layer. In some aspects, the mesh layer reaches tensile strength of 9,000 pounds per square inch (psi).

Referring now to FIG. 8, an illustration of an example layer of PETG polymeric material 800. Similar to the example in FIG. 5, the polymeric material provides the “glue” that allows the multiple layers to fuse together given the steps of heating, cooling, and compressing. Further, the variability in the polymeric layer allows for making multiplayer composite strips that bond to other extrusions and increases the fields in which the multilayer composite strip may be applied.

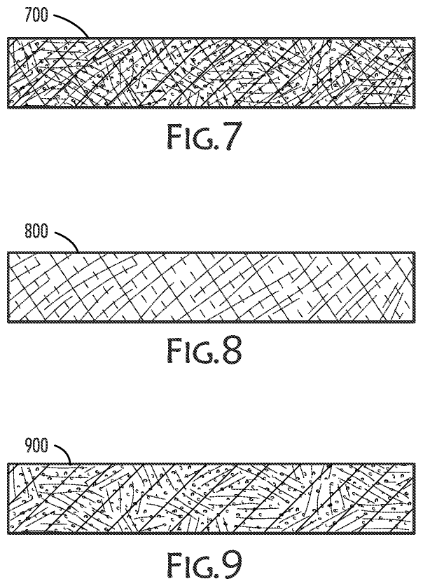

Referring now to FIG. 9, an illustration of an example layer of shredded fibrous material 900. In the example bast fibres are utilized to form the composite layer adding both tensile strength and rigidity to the multilayer composite strip. Further, such usage of bast fibres allows for decreased environmental harm, and allows the composite layer to be a renewable layer. Further, the composite layer may also be fortified with a blend of other composites, for example bast fibre may also include fiberglass to form a composite layer with beneficial properties from both materials.

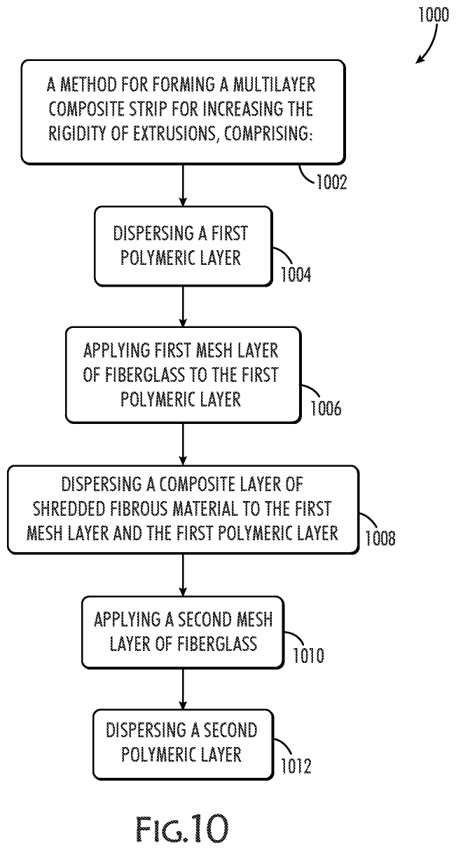

Referring now to FIG. 10, a flow diagram of an example method of forming a multilayer composite strip 1000. In the example method 1002 a first polymeric layer is dispersed 1004 on a conveyor or belt that is subjected to heat to melt or liquefy the first polymeric layer. This layer may also interact with a roller for compression or cooling to allow the flow rate and viscous level for adhering to and mixing within a first mesh layer 1006. The first polymeric layer then melts or bonds mechanically to the first mesh layer, wherein a composite layer (shredded fibrous material and pelletized polymeric material) is dispersed 1008. The composite layer forms the strength layer and bonds, in some cases chemically and mechanically with the polymeric layers and the mesh layers. Following an additional mesh layer 1010 and a polymeric layer 1012 may be conveyed on top of the previous layers, wherein the layers may be heated to congeal further and compressed by rollers to an exact size for co-extrusion with other polymers. This is but one example, other configurations may comprise two, three, or four composite layers, with only polymeric layers binding. Similarly, the mesh layer may only exist on the top and bottom portion, and the middle portion may be layers of composite material and polymeric material.

Discussing further herein, technical aspects measuring stiffness, also known as rigidity. Rigidity is a property of polymers and other materials that is described by flexural modulus or bending modulus of elasticity. Flexural modulus denotes the ability of a material to bend, it is the measure of a materials rigidity or resistance to bend when a force is applied perpendicular to the long edge—this is often referred to as a three-point bend test. The flexural modulus is represented by the slope of the initial straight line portion of the stress-strain curve and is calculated by dividing the change in stress by the corresponding change in strain. Thus, the ratio of stress to strain is a measure of flexural modulus.

The formula for a modulus of elasticity is determined under International Standard to measure in Pascal's (Pa or N/m\hat{ }2). The standards applied and incorporated herein by references are ASTM D790 and ISO 178. For ASTM, the test is stopped when specimens reach 5% deflection or the specimen breaks before 5%. For ISO 178, the test is stopped when the specimen breaks.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A multilayer composite strip for increasing rigidity in polymeric materials, comprising:
a first polymeric layer with a layer height ranging from 0.23 mm to 1.1 mm;
a first mesh layer, wherein at least 20 percent of the first mesh layer is a void region;
a composite layer of shredded fibrous material and polymeric material, wherein the shredded fibrous material is of an average length between 5.0 mm and 50 mm, and the polymeric material has a particulate size from 50 microns to 2000 microns prior to heating;
a second mesh layer, wherein at least 20 percent of the second mesh layer is a void region; and
a second polymeric layer with a layer height from 0.23 mm to 1.1 mm.

2. The multilayer composite strip of claim 1, wherein the first polymeric layer and the second polymeric layer is comprised of polyethylene terephthalate (PET) or polyethylene terephthalate glycol (PETG).

3. The multilayer composite strip of claim 1, wherein the first polymeric layer is comprised of polyvinyl chloride (PVC).

4. The multilayer composite strip of claim 1, wherein the first polymeric layer further comprises polyamides.

5. The multilayer composite strip of claim 1, wherein the first mesh layer and the second mesh layer have a window size between 1 mm to 12 mm.

6. The multilayer composite strip of claim 1, wherein the composite layer of the shredded fibrous material is a combination of shredded carbon fiber and shredded fiberglass.

7. The multilayer composite strip of claim 1, wherein the composite layer of the shredded fibrous material is shredded carbon fiber or shredded fiberglass.

8. The multilayer composite strip of claim 1, wherein the composite layer of the shredded fibrous material is shredded bast fibre.

9. The multilayer composite strip of claim 1, further comprising a third mesh layer, a second composite layer of the shredded fibrous material and the polymeric material, and a third polymeric layer, the second composite layer being of a different shredded fibrous material than the first composite layer.

10. The multilayer composite strip of claim 1, wherein the multilayer composite strip is between 1 mm to 20 mm in height and up to 550 mm in width.

11. The multilayer composite strip of claim 1, wherein the first and second mesh layer have a tensile strength of 9,000 psi.

12. The multilayer composite strip of claim 1, wherein the multilayer composite strip is water resistant and noncorrosive.

13. The multilayer composite strip of claim 1, wherein the first polymeric layer, the first mesh layer, the composite layer, the second mesh layer, and the second polymeric layer are integrated to form a solid layer.

14. A multilayer composite strip for increasing rigidity, comprising:
a first polymeric layer with a layer height ranging from 0.23 mm to 1.1 mm;
a first mesh layer of fiberglass, wherein at least 20 percent of the first mesh layer is a void region;
a composite layer of shredded fibrous material and polymeric material, wherein the shredded fibrous material is of an average length between 5.0 mm and 50 mm, and the polymeric material has a particulate size from 50 microns to 2000 microns prior to forming the composite layer; and
a second polymeric layer with a layer height from 0.23 mm to 1.1 mm.

15. The multilayer composite strip of claim 14, wherein the first polymeric layer and the second polymeric layer is comprised of polyethylene terephthalate (PET) or polyethylene terephthalate glycol (PETG).

16. The multilayer composite strip of claim 14, wherein the first polymeric layer is comprised of polyvinyl chloride (PVC).

17. The multilayer composite strip of claim 14, wherein the first mesh layer and the second mesh layer have a window size between 1 mm to 12 mm.

18. The multilayer composite strip of claim 14, wherein the composite layer of the shredded fibrous material is a combination of shredded carbon fiber and shredded fiberglass.

19. The multilayer composite strip of claim 14, wherein the composite layer of the shredded fibrous material is shredded carbon fiber or shredded fiberglass.

20. The multilayer composite strip of claim 14, wherein the composite layer of the shredded fibrous material is shredded bast fibre.

21. The multilayer composite strip of claim 14, further comprising a third mesh layer, a second composite layer of the shredded fibrous material and the polymeric material, and a third polymeric layer, the second composite layer being of a different shredded fibrous material than the first composite layer.
